(19) United States
(12) Patent Application Publication
(10) Pub. No.: US 2014/0284252 A1
(43) Pub. Date: Sep. 25, 2014

(54) VEGETATION BYPRODUCT EXTRACTION APPARATUS

(71) Applicant: ENOVATORS, LLC, ASHLAND, OR (US)

(72) Inventors: ERIC FRANKLIN SFRAGIDAS, ROGUE RIVER, OR (US); WILLIAM STACY PAGE, ASHLAND, OR (US)

(73) Assignee: ENOVATORS, LLC, ASHLAND, OR (US)

(21) Appl. No.: 14/176,949

(22) Filed: Feb. 10, 2014

Related U.S. Application Data
(60) Provisional application No. 61/852,821, filed on Mar. 22, 2013.

(51) Int. Cl. B07B 1/34

(52) U.S. Cl. CPC B07B 1/34
USPC 209/235

(57) ABSTRACT

A vegetation byproduct extraction apparatus includes an apparatus frame; an extraction assembly mount frame pivotally carried by the apparatus frame; an extraction assembly including a container carried by the extraction assembly mount frame; an agitation motor mechanically engaging the container; at least one classifier carried by the container, the at least one classifier having a classifier mesh with a plurality of mesh openings; a collection pan carried by the at least one classifier; and at least one assembly securing mechanism engaging the container and the collection pan, the at least one assembly securing mechanism releasably securing the collection pan and the at least one classifier on the container.

### CROSS-REFERENCE TO RELATED APPLICATIONS

This application claims the benefit of U.S. provisional application No. 61/852,821, filed Mar. 22, 2013 and entitled “SHOCKWAVE HERBAL EXTRACTOR THAT MECHANICALLY SEPARATES OUT OILS FROM THE PLANT TO BE USED FOR MANY PRODUCTS”, which provisional application is hereby incorporated by reference herein in its entirety.

### FIELD OF THE INVENTION

Illustrative embodiments of the disclosure relate to apparatuses and methods for extracting herbs, oils and/or other byproducts from plants and other vegetation. More particularly, illustrative embodiments of the disclosure relate to a vegetation byproduct extraction apparatus which expeditiously extracts various plant and other vegetation byproducts from vegetation material through a dry mechanical agitation process.

### BACKGROUND OF THE INVENTION

Various processes are known for extracting herbs, oils and/or other byproducts from plants and other vegetation. These processes may utilize liquids to extract the by-products through implementation of intricate processes using complex equipment, rendering the processes expensive and complicated and requiring long drying periods. An herbal extraction apparatus which expeditiously classifies various plant by-products through a dry mechanical agitation process is needed.

### SUMMARY OF THE INVENTION

Illustrative embodiments of the disclosure are generally directed to a vegetation byproduct extraction apparatus for extracting various plant and other vegetation byproducts from vegetation material through a dry mechanical agitation process. An illustrative embodiment of the apparatus includes an apparatus frame; an extraction assembly mount frame pivotally carried by the apparatus frame; an extraction assembly including a container carried by the extraction assembly mount frame; an agitation motor mechanically engaging the container; at least one classifier carried by the container, the at least one classifier having a classifier mesh with a plurality of mesh openings; a collection pan carried by the at least one classifier; and at least one assembly securing mechanism engaging the container and the collection pan, the at least one assembly securing mechanism releasably securing the collection pan and the at least one classifier on the container.

### BRIEF DESCRIPTION OF THE DRAWINGS

Illustrative embodiments of the disclosure will now be described, by way of example, with reference to the accompanying drawings, in which:

FIG. 1 is a perspective view of an illustrative embodiment of the vegetation byproduct extraction apparatus;

FIG. 2 is an exploded perspective view of an illustrative vegetation byproduct extraction apparatus;

FIG. 3 is a perspective view of a typical apparatus frame and extraction assembly support frame according to an illustrative vegetation byproduct extraction apparatus;

FIG. 4 is a side view of a typical apparatus frame and extraction assembly support frame;

FIG. 5 is a perspective view of a typical apparatus frame and extraction assembly support frame;

FIG. 6 is a front view of a typical apparatus frame and extraction assembly support frame;

FIG. 7 is a top view of a typical apparatus frame and extraction assembly support frame;

FIG. 8 is a side view of an illustrative embodiment of the vegetation byproduct extraction apparatus, with an extraction assembly of the apparatus deployed in an upright loading position in exemplary application of the apparatus;

FIG. 9 is a side view of the illustrative vegetation byproduct extraction apparatus with the extraction assembly deployed in an inverted unloading position in exemplary application of the apparatus;

FIG. 10 is a cross-sectional view of a typical collection pan of the extraction assembly; and

FIG. 11 is a cross-sectional view of a typical classifier of the extraction assembly.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Moreover, the illustrative embodiments described herein are not exhaustive and embodiments or implementations other than those which are described herein and which fall within the scope of the appended claims are possible. Furthermore, there is no intention to be bound by any expressed or implied theory presented in the preceding technical field, background, brief summary or the following detailed description. Relative terms such as “bottom” and “top” herein are used with reference to relative positions of various elements with respect to each other in exemplary application of the vegetation byproduct extraction apparatus and are not intended to be used in a limiting sense.

Referring to the drawings, an illustrative embodiment of the vegetation byproduct extraction apparatus, hereinafter apparatus, is generally indicated by reference numeral 1. The apparatus 1 may include an apparatus frame 2. An extraction assembly mount frame 30 may be supported by the apparatus frame 2. An extraction assembly 39 may be supported by the extraction assembly mount frame 30. In exemplary application of the apparatus 1, which will be hereinafter described, the extraction assembly 39 may be used to extract pollen, herbs, oils and/or other vegetation byproducts from plant matter or other vegetation for any of a variety of purposes.

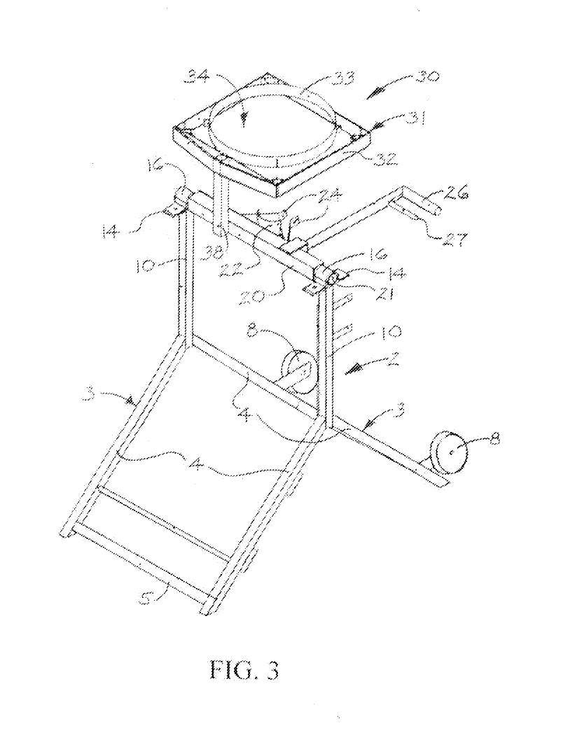

In some embodiments, the apparatus frame 2 of the apparatus 1 may include a pair of angled frame legs 3. A pair of elongated, parallel, spaced-apart, upward-standing frame arms 10 may extend from between the frame legs 3. Each frame leg 3 may include a pair of spaced-apart side leg members 4 which extend at an angle from the respective frame arms 10. A bottom leg member 5 may extend between the side leg members 4. As illustrated in FIGS. 3-5, in some embodiments, a pair of frame wheels 8 may be provided on one of the frame legs 3 to render the apparatus 1 portable on a flat surface (not illustrated). In some embodiments, the apparatus frame 2 may be fabricated of square tubing components from steel, aluminum, plastic and/or other material.

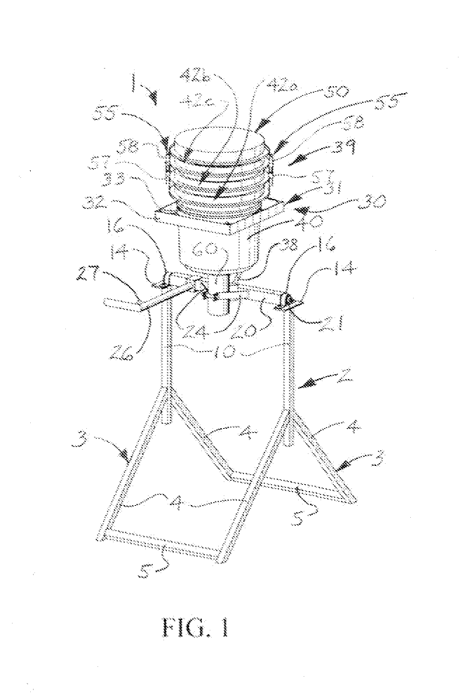

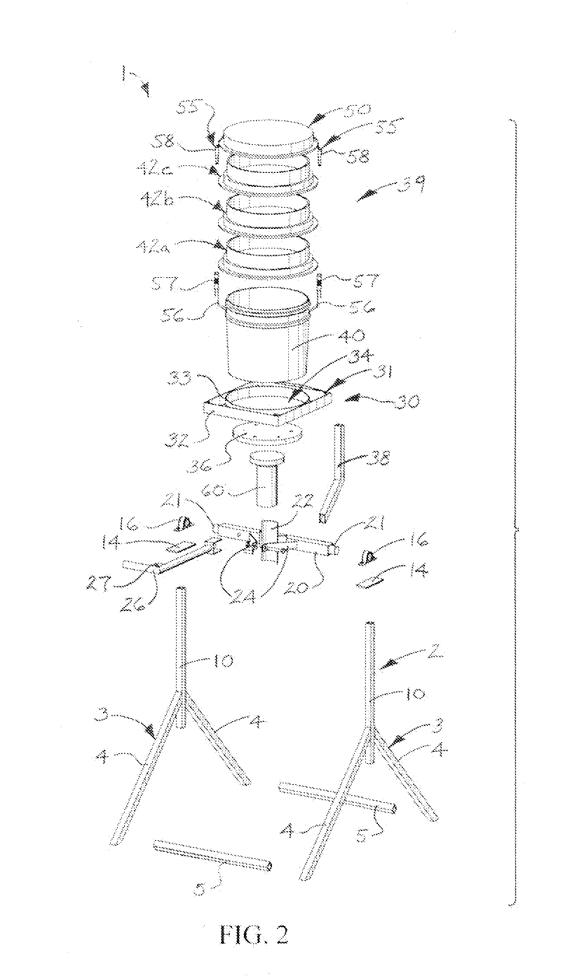

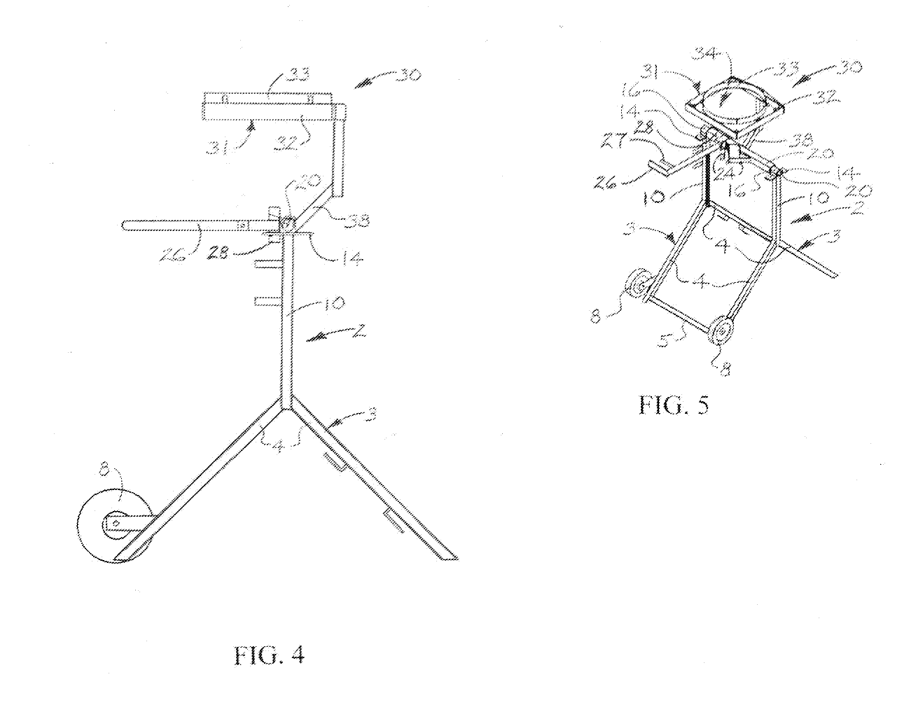

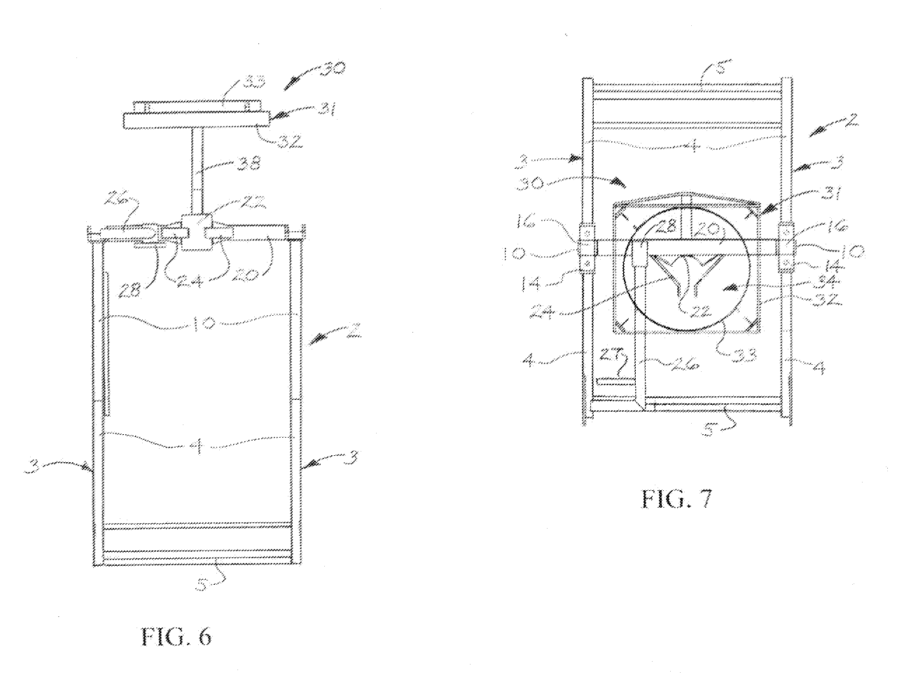

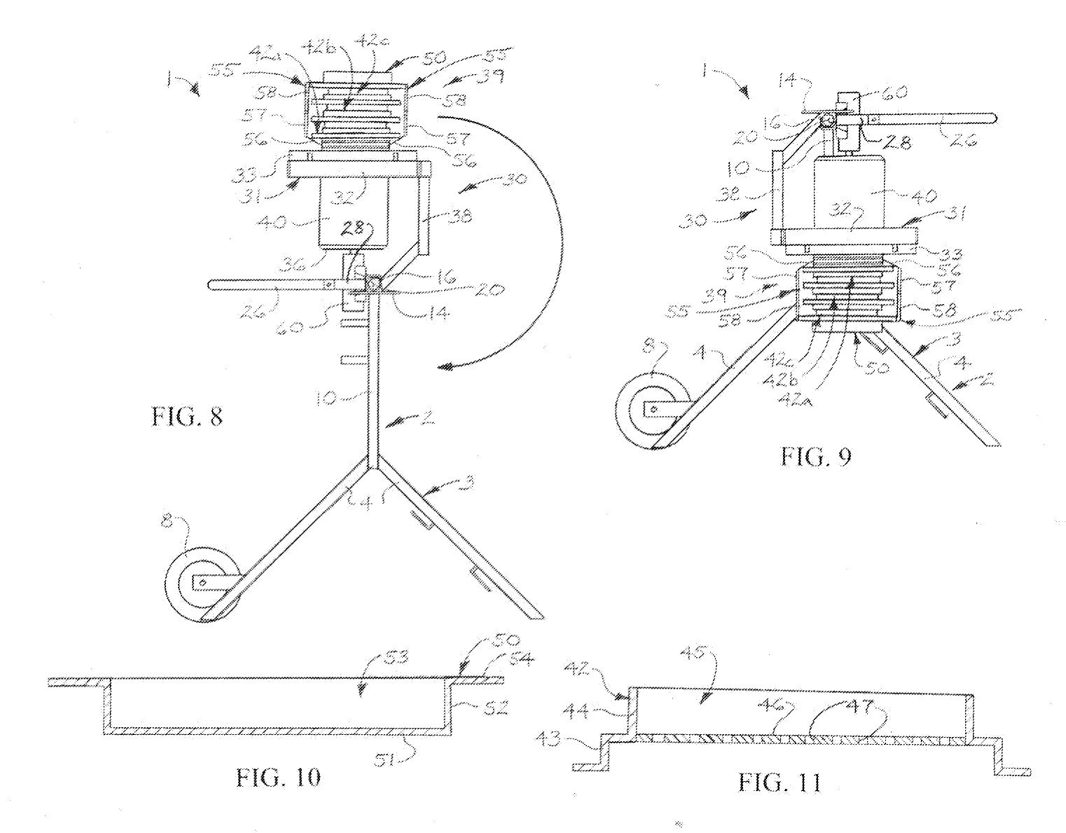

As particularly illustrated in FIGS. 1-7, the extraction assembly mount frame 30 of the apparatus 1 may be provided on the apparatus frame 2. The extraction assembly mount frame 30 may include an extraction assembly support member 20 which is supported by the frame arms 10 of the apparatus frame 2. The extraction assembly support member 20 may be rotatably mounted relative to the frame arms 10 according to any suitable technique known by those skilled in the art. In some embodiments, a pair of bearing mount plates 14 may terminate the upper ends of the respective frame arms 10. A pair of shaft bearings 16 may be provided on the respective bearing mount plates 14. The respective ends of the extraction assembly support member 20 may terminate in a pair of support member bearings 21 which are inserted into the respective shaft bearings 16 such that the extraction assembly support member 20 is capable of rotating 360 degrees about its longitudinal axis. An extraction assembly positioning handle 26 may extend from the extraction assembly support member 20 to facilitate manual rotation of the extraction assembly support member 20 and selective deployment of the extraction assembly mount frame 30 in an upright material loading position (FIG. 8) for purposes which will be hereinafter described. Accordingly, a frame locking mechanism 28 (FIGS. 4-9) on the extraction assembly support member 20 may selectively engage one or both of the shaft bearings 16 according to the knowledge of those skilled in the art to facilitate locking of the extraction assembly mount frame 30 in the upright material loading position. A handle trigger 27 may be provided on the extraction assembly positioning handle 26 to operably engage the frame locking mechanism 28 and facilitate selective engagement of the frame locking mechanism 28 with the shaft bearing or bearings 16 upon release of the handle trigger 27 and disengagement of the frame locking mechanism 28 from the shaft bearing or bearings 16 upon depression of the handle trigger 27.

The extraction assembly mount frame 30 may further include a frame base 31 having a generally square-shaped sleeve support 32 and a container sleeve 33 in the sleeve support 32. The container sleeve 33 has a container sleeve opening 34. An assembly stabilizing arm 38 may mount the sleeve support 32 of the frame base 31 on the extraction assembly support member 20.

The extraction assembly 39 of the apparatus 1 may include a container 40 which is nested in the container sleeve opening 34 in the container sleeve 33 of the frame base 31 on the extraction assembly mount frame 30. The container 40 is sized and configured to contain the plant matter or other vegetation (not illustrated) from which the vegetation byproducts are to be extracted, in addition to a supply of dry ice (not illustrated). A vibrating agitation motor 60 may be mounted on the extraction assembly support member 20 of the extraction assembly mount frame 30 beneath the container 40. The agitation motor 60 mechanically engages the container 40 for selective vibration of the container 40 according to the knowledge of those skilled in the art. Accordingly, a resilient dampening pad 36 may be attached to the bottom of the container 40 through fasteners (not illustrated) and/or other attachment technique. The agitation motor 60 engages the dampening pad 36 and vibrates the container 40 through the dampening pad 36 in application of the apparatus 1, which will be hereinafter described. A motor switch (not illustrated) may be electrically connected to the agitation motor 60 and mounted on the apparatus frame 2, the extraction assembly mount frame 30 or any other suitable component of the apparatus 1 to facilitate selective operation of the agitation motor 60. In some embodiments, the motor switch may include a speed control dial or other mechanism to selectively vary the vibrational speed of the agitation motor 60.

The agitation motor 60 may be mounted on the extraction assembly support member 20 of the extraction assembly mount frame 30 according to any suitable technique which is known by those skilled in the art. In some embodiments, a concave motor mount plate 22 may be welded, fastened and/or otherwise attached to the extraction assembly support member 20. A pair of spaced-apart agitation motor mount arms 24 may extend from the extraction assembly support member 20 on opposite sides of the motor mount plate 22. The agitation motor mount arms 24 may secure the agitation motor 60 against the motor mount plate 22 to mount the agitation motor 60 on the extraction assembly support member 20. The agitation motor 60 may be additionally or alternatively mounted on the extraction assembly support member 20 using mechanical fasteners (not illustrated) and/or other attachment technique which is suitable for the purpose.

The extraction assembly 39 further includes at least one classifier 42 which is placed on the container 40 when the extraction assembly 39 is deployed in the upright loading position illustrated in FIG. 8. As illustrated in FIG. 11, each classifier 42 may include a classifier base 43 and a classifier wall 44 which extends from the classifier base 43 and has a classifier interior 45. A classifier mesh 46 having mesh openings 47 of selected size is provided in the classifier interior 45. As illustrated in FIGS. 1, 2, 8 and 9, in exemplary application of the apparatus 1, multiple classifiers 42 are placed on the container 40. In the example illustrated, a first classifier 42a is placed on the container 40; a second classifier 42b is placed on the first classifier 42a; and a third classifier 42c is placed on the second classifier 42b. The mesh openings 47 (FIG. 11) in the classifier mesh 46 of the first classifier 42a, the second classifier 42b and the third classifier 42c may have different sizes for purposes which will be hereinafter described. In some embodiments, the first classifier 42a, the second classifier 42b and the third classifier 42c may have mesh openings 47 of progressively decreasing size.

The extraction assembly 39 further includes a collection pan 50 which is placed on the classifier or classifiers 42 when the extraction assembly 39 is deployed in the upright loading position illustrated in FIG. 8. As illustrated in FIG. 10, the collection pan 50 may include a collection pan bottom 51, a collection pan wall 52 extending from the collection pan bottom 51, a collection pan interior 53 formed by the collection pan wall 52 and a collection pan rim 54 which extends outwardly from the collection pan wall 52.

At least one assembly securing mechanism 55 engages and secures the classifier or classifiers 42 and the collection pan 50 to the container 40 of the extraction assembly 39. The assembly securing mechanism 55 may have any design or construction which is suitable for the purpose. In some embodiments, each assembly securing mechanism 55 may include a connecting strap 56 which is attached to and extends from the container 40. A bottom connector 57 may be provided on the connecting strap 56. A top connector 58 may be provided on the collection pan 50. The top connector 58 is complementary to the bottom connector 57 and detachably engages the bottom connector 57 to secure the classifier or classifiers 42 and the collection pan 50 on the container 40 as the extraction assembly mount frame 30 and extraction assembly 39 thereon are repositioned from the upright loading position illustrated in FIG. 8 to the inverted unloading position illustrated in FIG. 9, as will be hereinafter described.

Referring next to FIGS. 8-11 of the drawings, in exemplary application, the apparatus 1 may be used to extract vegetation material particles of pollen, herbs, oils and/or other vegetation byproducts from plant matter or other vegetation material for any of a variety of purposes. Accordingly, the extraction assembly mount frame 30 and the extraction assembly 39 thereon are initially deployed in the upright vegetation material-loading position illustrated in FIG. 8 typically by rotation of the assembly positioning handle 26 and manual release of the handle trigger 27, such that the frame locking mechanism 28 engages the shaft bearing or bearings 28 and locks the extraction assembly mount frame 30 in the upright position. The assembly securing mechanisms 55 are unfastened and the classifiers 42 and the collection pan 50 are removed from the container 40. A vegetation material (not illustrated), which may have been previously pulverized or shredded using a conventional mechanical pulverizing or shredding process, and a supply of frozen carbon dioxide (dry ice) are placed in the container 40. Next, at least one of the classifiers 42 is placed on the container 40, the collection pan 50 is placed on the classifier or classifiers 42 and the assembly securing mechanisms 55 are fastened.

In subsequent operation of the apparatus 1, which will be hereinafter described, the classifier or classifiers 42 that were selected and secured in the extraction assembly 39 will sift and remove vegetation particles having a selected size from the vegetation material which was placed in the container 40. Which of the classifiers 42 is selected may depend on the size of the mesh openings 47 (FIG. 11) in the classifier mesh 46 of the classifier or classifiers 42 and thus, the size of the vegetation particles which are to be extracted from the plant or vegetation matter and collected in the collection pan 50. For example and without limitation, in some applications, the first classifier 42a (having the largest mesh openings 47) may be secured in the extraction assembly 39 to facilitate removal of the largest vegetation particles from the vegetation material. In some applications, both the first classifier 42a and the second classifier 42b (having the intermediate-sized mesh openings 47) may be secured in the extraction assembly 39 to remove both the largest and the intermediate-sized vegetation particles from the vegetation material. In still other applications, the first classifier 42a, the second classifier 42b and the third classifier 42c may be secured in the extraction assembly 39 to remove large, intermediate and small vegetation material particles from the vegetation material such that only the vegetation particles which are smaller than the size of the mesh openings 47 in the third classifier 42c and/or oils are removed from the vegetation material and fall into the collection pan 50.

After the selected classifier or classifiers 42 is/are secured in the extraction assembly 39, the agitation motor 60 is operated to vibrate the container 40 at a selected vibrational speed and for a selected operating time (such as 5 minutes, for example and without limitation). Accordingly, vibration of the container 40 loosens the vegetation material in the container 40 preporatory to sifting. The dry ice which was placed in the container 40 with the vegetation material freezes the vegetation particles and aids in separation of oil from the particles. The vibrational speed and operating time for the agitation motor 60 may depend on such factors as the type of vegetation material which is selected for sifting as well as the size of the vegetation particles which are to be removed from the vegetation material.

As illustrated in FIGS. 8 and 9, after vibration of the container 40, the assembly positioning handle 26 is operated to reposition the extraction assembly mount frame 30 and extraction assembly 39 from the upright material-loading position illustrated in FIG. 8 to the inverted material-unloading position illustrated in FIG. 9. Accordingly, the handle trigger 27 on the extraction assembly positioning handle 26 may initially be squeezed, depressed or otherwise manipulated to facilitate disengagement of the frame locking mechanism 28 from the shaft bearing or bearings 16, after which the assembly repositioning handle 26 is rotated to reposition the extraction assembly mount frame 30, as indicated by the arrow in FIG. 8. Inversion of the extraction assembly 39 causes the vegetation material to fall from the container 40, through the classifier or classifiers 42 previously secured in the extraction assembly 39 and into the collection pan 50. Thus, only the vegetation particles which are smaller than the smallest mesh openings 47 (FIG. 11) in the classifier or classifiers 42 and/or oil extracted from the vegetation material falls into the collection pan 50. The assembly securing mechanisms 55 are next unfastened and the collection pan 50 and classifier or classifiers 42 are removed from the container 40. The vegetation particles and/or oil which were collected are removed from the collection pan 50 and may be stored or further processed depending on the desired use of the vegetation particles. In some applications, the process may be repeated to ensure complete removal of the vegetation particles of selected size from the vegetation material. The collection pan 50, classifier or classifiers 42 and container 40 may then be cleaned for subsequent use.

While illustrative embodiments of the disclosure have been described above, it will be recognized and understood that various modifications can be made in the disclosure and the appended claims are intended to cover all such modifications which may fall within the spirit and scope of the disclosure.

What is claimed is:

1. A vegetation byproduct extraction apparatus, comprising:
an apparatus frame;
an extraction assembly mount frame pivotally carried by the apparatus frame;
an extraction assembly including:
a container carried by the extraction assembly mount frame;
an agitation motor mechanically engaging the container;
at least one classifier carried by the container, the at least one classifier having a classifier mesh with a plurality of mesh openings;
a collection pan carried by the at least one classifier; and
at least one assembly securing mechanism engaging the container and the collection pan, the at least one assembly securing mechanism releasably securing the collection pan and the at least one classifier on the container.

2. The apparatus of claim 1 further comprising an assembly positioning handle carried by the extraction assembly mount frame.

3. The apparatus of claim 2 further comprising a frame locking mechanism carried by the extraction assembly mount frame and releasably engaging the apparatus frame and a handle trigger carried by the assembly positioning handle and engaging the frame locking mechanism.

4. The apparatus of claim 1 wherein the extraction assembly mount frame comprises an extraction assembly support member rotatably carried by the apparatus frame, and wherein the container is carried by the extraction assembly support member.

5. The apparatus of claim 4 further comprising a motor mount plate carried by the extraction assembly support member and a pair of agitation motor mount arms carried by the extraction assembly support member on opposite sides of the motor mount plate, and wherein the agitation motor is carried by the motor mount plate and the pair of agitation motor mount arms.

6. The apparatus of claim 4 wherein the extraction assembly mount frame comprises a frame base carried by the extraction assembly support member, and wherein the container of the extraction assembly is carried by the frame base.

7. The apparatus of claim 6 wherein the frame base comprises a sleeve support, a container sleeve carried by the sleeve support and a container sleeve opening in the container sleeve, the container of the extraction assembly seated in the container sleeve opening.

8. The apparatus of claim 1 wherein the apparatus frame comprises a pair of angled frame legs and a pair of spaced-apart frame arms extending from between the frame legs, and the extraction assembly mount frame is pivotally carried by the frame arms.

9. A vegetation byproduct extraction apparatus, comprising:
an apparatus frame;
an extraction assembly mount frame pivotally carried by the apparatus frame, the extraction assembly mount frame selectively positional in an upright material loading position and an inverted material unloading position;
an extraction assembly including:
a container carried by the extraction assembly mount frame;
an agitation motor mechanically engaging the container;
at least one classifier carried by the container, the at least one classifier including:
a classifier base;
a classifier wall extending from the classifier base;
a classifier interior formed by the classifier wall; and
a classifier mesh carried by the classifier wall and having a plurality of mesh openings;
a collection pan carried by the at least one classifier; and
at least one assembly securing mechanism engaging the container and the collection pan, the at least one assembly securing mechanism releasably securing the collection pan and the at least one classifier on the container.

10. The apparatus of claim 9 further comprising an assembly positioning handle carried by the extraction assembly mount frame.

11. The apparatus of claim 10 further comprising a frame locking mechanism carried by the extraction assembly mount frame and releasably engaging the apparatus frame and a handle trigger carried by the assembly positioning handle and engaging the frame locking mechanism.

12. The apparatus of claim 9 wherein the extraction assembly mount frame comprises an extraction assembly support member rotatably carried by the apparatus frame, and wherein the container is carried by the extraction assembly support member.

13. The apparatus of claim 12 further comprising a motor mount plate carried by the extraction assembly support member and a pair of agitation member mount arms carried by the extraction assembly support member on opposite sides of the motor mount plate, and wherein the agitation motor is carried by the motor mount plate and the pair of agitation member mount arms.

14. The apparatus of claim 12 wherein the extraction assembly mount frame comprises a frame base carried by the extraction assembly support member, and wherein the container of the extraction assembly is carried by the frame base.

15. The apparatus of claim 14 wherein the frame base comprises a sleeve support, a container sleeve carried by the sleeve support and a container sleeve opening in the container sleeve, the container of the extraction assembly seated in the container sleeve opening.

16. The apparatus of claim 9 wherein the apparatus frame comprises a pair of angled frame legs and a pair of spaced-apart frame arms extending from between the frame legs, and the extraction assembly mount frame is pivotally carried by the frame arms.

17. A vegetation byproduct extraction apparatus, comprising:
an apparatus frame;
an extraction assembly mount frame selectively positional in an upright material loading position and an inverted material unloading position, the extraction assembly mount frame including:
an extraction assembly support member rotatably carried by the apparatus frame;
an assembly stabilizing arm carried by the extraction assembly support member;
a frame base carried by the assembly stabilizing arm;
an assembly positioning handle carried by the extraction assembly support member;
a frame locking mechanism carried by the extraction assembly mount frame and releasably engaging the apparatus frame; and
a handle trigger carried by the assembly positioning handle and engaging the frame locking mechanism;
an extraction assembly including:
a container carried by the frame base of the extraction assembly mount frame;
an agitation motor carried by the extraction assembly support member, the agitation motor mechanically engaging the container;
a plurality of classifiers carried by the container, the plurality of classifiers each including:
a classifier base;
a classifier wall extending from the classifier base;
a classifier interior formed by the classifier wall; and
a classifier mesh carried by the classifier wall and having a plurality of mesh openings;
the plurality of mesh openings of the plurality of classifiers having different sizes, respectively;
a collection pan carried by the at least one classifier; and
at least one assembly securing mechanism engaging the container and the collection pan, the at least one assembly securing mechanism releasably securing the collection pan and the at least one classifier on the container.

18. The apparatus of claim 17 wherein the frame base comprises a sleeve support, a container sleeve carried by the sleeve support and a container sleeve opening in the container sleeve, the container of the extraction assembly seated in the container sleeve opening.

19. The apparatus of claim 17 wherein the apparatus frame comprises a pair of angled frame legs and a pair of spaced-apart frame arms extending from between the frame legs, and the extraction assembly mount frame is pivotally carried by the frame arms.

20. The apparatus of claim 17 further comprising a motor mount plate carried by the extraction assembly support member and a pair of agitation motor mount arms carried by the extraction assembly support member on opposite sides of the motor mount plate, and wherein the agitation motor is carried by the motor mount plate and the pair of agitation motor mount arms.
